(19) United States
(12) Patent Application Publication
(10) Pub. No.: US 2010/0194539 A1
(43) Pub. Date: Aug. 5, 2010

(54) POWER SOCKET FASCIA

(75) Inventor: Andrew Delamare, London (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: EN-TWYN LTD., London (GB)

(21) Appl. No.: 12/668,383

(22) PCT Filed: Jul. 11, 2008
(86) PCT No.: PCT/GB2008/002379

§ 371 Date: Apr. 14, 2010

(30) Foreign Application Priority Data
Jul. 11, 2007 (GB) 0713445.5

(51) Int. Cl. H04Q 5/22; G05B 11/01

(52) U.S. Cl. 340/10.1; 340/310.18

(57) ABSTRACT

A power socket fascia arranged to be fitted to a power socket box. The fascia comprises at least one power socket for receiving a plug of an electrical device and including coupling elements for electrically coupling said power socket to a power-line. The fascia includes at least one port for the transmission and/or reception of a signal, in which said at least one port is coupled to a processor electrically coupled to said power-line. The processor is arranged to transfer a signal between said at least one port and said power-line so that said signal can be transmitted to and/or received from said power-line.

### FIELD OF THE INVENTION

The present invention relates to a power socket fascia.

### BACKGROUND TO THE INVENTION

The HomePlug® Powerline Alliance, a non-profit industry association, was formed in March 2000 by a group of industry-leading companies to support standards based power-line networking products.

Devices conforming to the HomePlug® technology standard comprise pins for insertion into a power socket (or other suitable means for electrically coupling the devices to a powerline). The devices additionally comprise processing circuitry and a data port for receiving a data cable linked to a network device. Data transmitted from (or to be received by) the network device can be transferred to/from a power-line by means of the HomePlug® device located in the power socket. In uploading a data signal to the power-line, the processing circuitry HomePlug® device processes the data signal received from the network device and subsequently uploads the processed data signal to the power-line through the pins of the HomePlug® device. Downloading a data signal from the power-line to the network device occurs in a similar manner, but the steps are reversed. A system incorporating such HomePlug® devices allows the network device to communicate with another network device coupled to the power-line via another HomePlug® device by using the power-line as the data signal transmission medium.

There are, however, problems and limitations associated with such known devices. First of all, the devices themselves are fairly bulky and the combination of device and socket has a high profile compared with the surrounding wall upon which the socket is mounted. Thus, it may often be difficult to locate the HomePlug® device in a socket located behind furniture which is positioned against a wall and adjacent to the socket.

In addition, the fact that the device must be plugged into the power socket means that the socket can no longer be used for receiving the plugs of other devices. Thus, in a household relying upon such technology and where, for example, there is at least one network device in each room of the household, the number of available power sockets in each room of the house is effectively reduced by one since one socket per room has a HomePlug® device coupled thereto.

The present invention seeks to provide for a power socket having advantages over known such devices.

### SUMMARY OF THE INVENTION

In this regard, the present invention provides a power socket fascia arranged to be fitted to a power socket box, comprising: at least one power socket for receiving a plug of an electrical device and including coupling elements for electrically coupling said power socket to a power-line; and at least one port for the transmission and/or reception of a signal, wherein said at least one port is coupled to a processor electrically coupled to said power-line and arranged to transfer a signal between said at least one port and said power-line so that said signal can be transmitted to and/or received from said power-line.

An advantage of the present invention is that, because the port is integral with the power socket fascia, the fascia offers a low profile, which will not protrude a great deal from a surface upon which the fascia is mounted. Additionally, as the port is coupled (via the processor) directly to the power-line (i.e. its own dedicated connection), the terminals of the power socket remain available for receiving a plug to enable power to be supplied to an electrical device.

Preferably, said processor can comprise a power-line interface and a port interface, said power-line interface being arranged to extract a signal from said power-line and/or upload a signal onto said power-line, and also being arranged to forward an extracted signal to said port interface for transfer of the signal to said port, and which, upon receipt of a signal at said port is arranged to transfer that signal to said power-line interface for upload to said power-line.

Conveniently, said processor can further comprise a signal amplifier coupled between said power-line interface and said port interface and arranged to amplify a signal prior to transmission on said power-line and/or upon reception of a signal by said power-line interface and before transferring the signal to said port interface.

Further, said processor can comprise a signal converter arranged to convert said signal extracted by said power-line interface from analogue to digital or vice versa prior to transfer to said port interface, and to convert a signal received by said port interface from analogue to digital or vice versa, prior to transfer to said power-line interface for upload to said power-line.

Preferably, said signal is a data signal, said port is a data port and said processor is a data processor.

Alternatively, said signal is an audio signal, said port is a audio port and said processor is an audio processor.

In particular, said data port can comprise a socket arranged for receiving a plug of a data cable.

Preferably, said plug comprises an RJ45-type plug.

Alternatively, said plug comprises a USB-type plug.

In yet a further alternative, said at least one audio port comprises a socket arranged for receiving a plug of an audio cable, and said plug comprises RCA audio, optical or RCA SPDIF digital type connector inputs or outputs.

Also, said power-line can comprise a (domestic) ring main.

In a further alternative, said port comprises means for the wireless transmission/reception of a signal to/from a network device, or can be arranged for connection to a transmission/reception means.

Preferably, the data port is provided in a front face of said power socket fascia.

Preferably, the power socket fascia further comprises a track, which is embedded in the fascia and in which an omni-directional aerial set is laid. Such an aerial is provided for the transmission/reception of signals from a wireless network. More than one aerial may be included if the power socket fascia includes data ports for more than one type of wireless connection.

The power socket fascia may further comprise a data connection information display. This may take the form of a series of LEDs or an LCD. The advantage of having a display is that a user is able to establish the condition of a connection. An LCD is preferable to LEDs because some consumers do not wish to have flashing lights visible.

Furthermore, the fascia may further comprise a heat conductor arranged to conduct heat generated by a component of the fascia from the fascia to a said power socket box. In order to comply with the relevant standards, power socket fasciae or wiring components must not overheat. The applicant has realised that the back box and the surrounding dry wall make an ideal heat sink. A heat conductor is therefore provided on the CLARIFY fascia in order to thermal link it to the power socket box.

According to another aspect of the present invention there is provided a network comprising a plurality of network devices, each network device being coupled to one of a plurality of power socket fascias as previously described, wherein said power socket fascias are arranged both to provide power outlets and to provide for signal transfer between said network devices, with said signal transfer being achieved through upload/download of signals via ports of the power socket fascias to/from a power-line.

According to yet another aspect of the present invention there is provided a power socket fascia arranged to be fitted to a power socket box, comprising at least one power socket for receiving a plug of an electrical device and at least one port.

The present invention further provides a power socket fascia arranged to be fitted to a power socket box, comprising: at least one power socket for receiving a plug of an electrical device and including coupling elements for electrically coupling said power socket to a power-line; a cartridge socket arranged to receive a cartridge, said cartridges having at least one port for the transmission and/or reception of a signal, wherein the fascia further comprises a processor electrically coupled to said cartridge socket and to said power-line and arranged, when a cartridge is located in said cartridge socket, to transfer a signal between said at least one port and said power-line so that said signal can be transmitted to and/or received from said power-line.

The present invention further provides a cartridge for insertion in the cartridge socket of the power socket fascia described above, the cartridge having at least one port for the transmission and/or reception of a signal.

In the above description, it should be understood that the term “signal” can include any signal such as a data signal, audio signal, video signal, multimedia signal or generally any non-power transmission.

Other features of the present invention are defined in the appended claims. Features and advantages associated with the present invention will be apparent from the following description of the preferred embodiments.

### BRIEF DESCRIPTION OF THE DRAWINGS

The present invention is described further hereinafter, by way of example only, with reference to the accompanying drawings in which:

FIG. 1 illustrates a perspective view of a power socket fascia according to an embodiment of the present invention;

FIG. 2 illustrates a schematic diagram of the circuitry of the power socket fascia when coupled to a power-line according to the embodiment of the present invention shown in FIG. 1;

FIG. 3 illustrates a schematic diagram of a local network incorporating power socket fascias of the present invention coupled to a power line;

FIG. 4 is a schematic diagram showing the network elements of a powerline network;

FIG. 5 is a schematic diagram showing the network elements of an alternative powerline network;

FIG. 6 illustrates a perspective view of a power socket fascia according to an alternative embodiment of the present invention;

FIG. 7 illustrates a schematic diagram of the circuitry of the power socket fascia when coupled to a power-line according the embodiment of the invention shown in FIG. 7;

FIG. 8 is a schematic diagram of an operating system model and hardware components in accordance with an embodiment of the invention;

FIG. 9 is a schematic diagram showing the network elements of an a powerline network in accordance with an embodiment of the present invention;

FIG. 10 is a front view of a cartridge in accordance with an embodiment of the invention;

FIG. 11 is a front view of a cartridge in accordance with an alternative embodiment of the invention;

FIG. 12 is a rear view of a cartridge in accordance with an embodiment of the invention;

FIG. 13 illustrates a wall having a power socket fascia in accordance with an embodiment of the invention installed therein;

FIG. 14 is a break away rear view of the inside of a fascia in accordance with an embodiment of the present invention;

FIG. 15 is a rear view of the inside of a fascia in accordance with an embodiment of the present invention;

FIG. 16 is a top view the inside of a fascia in accordance with an embodiment of the present invention;

FIG. 17 is a rear view a fascia in accordance with an embodiment of the present invention;

FIG. 18 is a top a fascia in accordance with an embodiment of the present invention;

### DESCRIPTION OF THE EMBODIMENTS

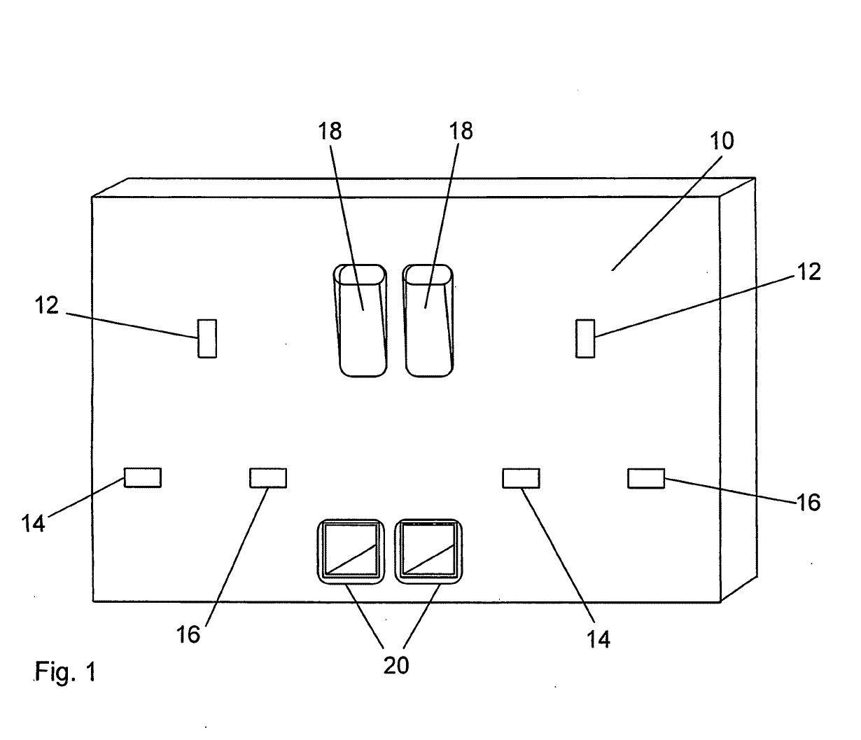

As mentioned, FIG. 1 illustrates a power socket fascia 10, which comprises socket apertures 12, 14, 16 associated with female terminals for receiving the pins of an electrical plug. The fascia 10 further comprises a switch 18 for controlling the supply of electricity to the terminals, and a data port 20 arranged to receive a plug attached to a network cable.

In the illustrated arrangement, the data port 20 is suitable for receiving an RJ45-type plug, but may be adapted to receive any type of network cable plug, or plug of a wireless terminal.

In FIG. 1, the socket apertures 12, 14, 16 are shown in an arrangement suitable for receiving a standard United Kingdom electrical three-pin plug (i.e. according to British Standard (BS) 1363) but it will be evident to the person skilled in the art that the present invention may be readily adapted for use with power sockets in any country.

Further, FIG. 1 illustrates a double-gang type power socket, but it should be appreciated that other arrangements, i.e. single, or triple-gang sockets, are possible.

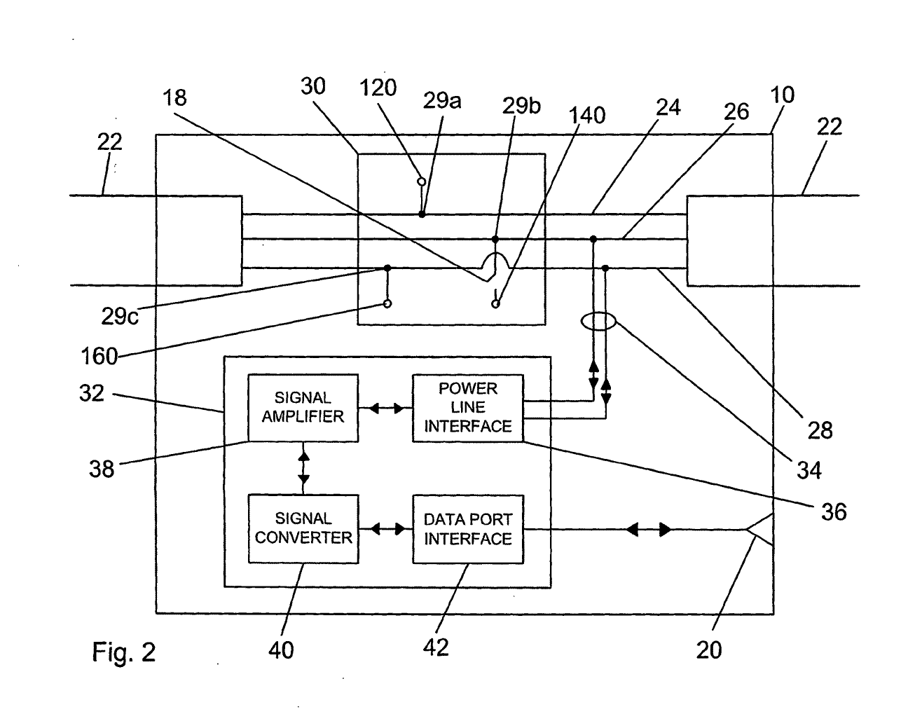

FIG. 2, illustrates the internal circuitry of the power socket fascia 10 schematically.

As can be seen, a power-line cable 22 (e.g. of a household “ring-circuit”) which contains an earth line 24, a live (phase) line 26, and a neutral line 28, is coupled to terminals 29a, 29b, 29c of a power element 30 of the power socket fascia 10. That is, the power element 30 of the power socket fascia 10 is electrically connected to the power-line cable 22 by way of terminal 29a connecting to earth line 24, terminal 29b connecting to live (phase) line 26, and terminal 29c connecting to neutral line 28. Terminals 29a, 29b, 29c are coupled to contacts 120, 140 and 160 respectively, and these contacts 120, 140, 160 correspond to the socket apertures 12, 14, 16 (see FIG. 1) for receiving the pins of an electric plug. Thus, when a plug is inserted into the power socket fascia 10, a pin inserted into terminal 12 will make electrical contact with contact 120, a pin inserted into terminal 14 will make contact with contact 140 and a pin inserted into terminal 16 will make contact with contact 160. This arrangement is well known in the art of coupling a power socket fascia to a power-line.

In addition to the standard arrangement to provide power to the power socket fascia, the power socket fascia is also provided with a data processor 32. A branch connection 34 couples the data processor 32 to the live (phase) and neutral lines 26, 28 of the power-line cable 22.

The data processor 32 comprises various elements, namely: a power-line interface 36; a signal amplifier 38; a signal converter 40; and a data port interface 42. The branch connection 34 terminates at the power-line interface 36 and electrically couples the power-line interface 36 to the live and neutral lines 26, 28 of power-line 22. Power-line interface 36 is coupled to signal amplifier 38 and the signal amplifier 38 is coupled to signal converter 40. In turn, signal converter 40 is coupled to data port interface 42 which, finally, is coupled to data port 20.

As stated above, the data port 20 is arranged to receive an RJ45-type plug attached to a Cat5 cable (or indeed any other suitable network cable) to allow a network device (e.g. a computer) to be connected for data exchange with a power socket fascia 10. A data signal transmitted by the network device (not shown) is received at the power socket fascia 10 by the data port 20 (shown also in FIG. 1) and subsequently transferred to data port interface 42. The data signal is subsequently transferred to signal converter 40 which is arranged to convert a digital data signal into an analogue data signal. This converted analogue data signal is then transferred to signal amplifier 38 and amplified to allow for better quality transmission of the signal over the power-line. After amplification in the signal amplifier 38, the converted analogue data signal is transferred to power-line interface 36 which transfers the converted analogue data signal to the live and neutral lines 26, 28 of the power-line 22.

A different network device situated at a different location is able to receive the data signal uploaded to the power-line 22 from the first network device by way of another power, socket fascia 10 according to the present invention and which is connected to the same power circuitry as the first power socket. In this second power socket fascia, the power-line interface 36 is arranged to extract the analogue data signal from live and neutral lines 26, 28 and transfer this data signal to signal amplifier 38 for amplification. In a preferred embodiment, the signal amplifier 38 determines if a data signal received from the power-line has amplitude above a predetermined threshold. If this is the case, amplification is not necessary prior to transfer to the network device, but if the signal amplitude is below the predetermined threshold amplification of the data signal occurs.

After processing by the signal amplifier 38, the received data signal is transferred to signal converter 40 for conversion to a digital data signal. The converted digital data signal is subsequently transferred to data port interface 42 which then transfers the converted digital data signal to data port 20 for onward transmission to the second network device.

Of course, and as stated previously, the present invention is easily adaptable to suit power socket fascias in countries other than the UK and so an earth line 24 (and corresponding earth pin terminal) may not always be required.

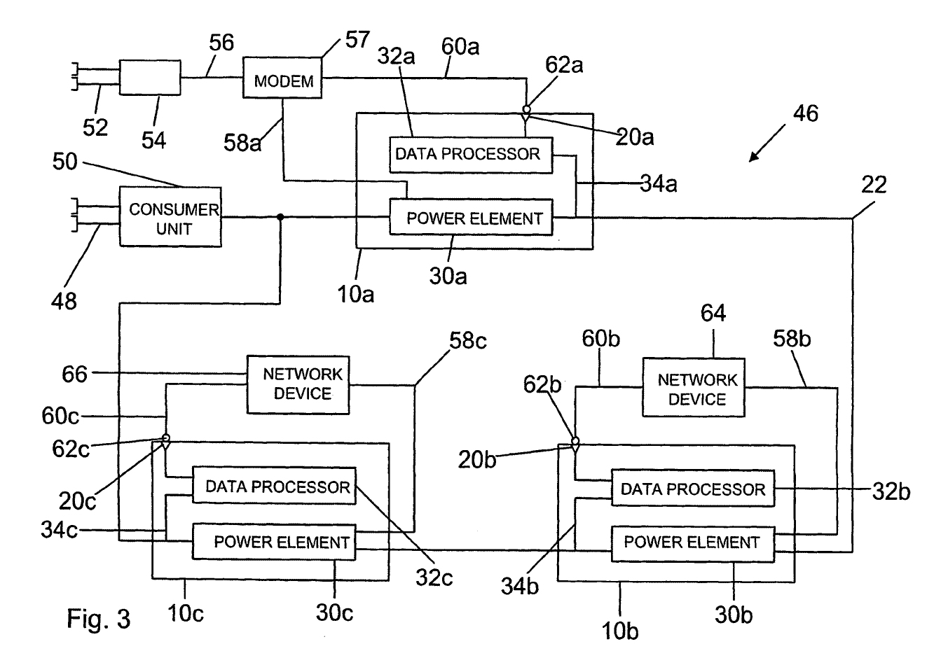

FIG. 3 illustrates an example of a domestic network 46 in which two network devices are suitably networked by way of the domestic ring-main circuitry as will be further described.

In the illustrated network 46 there are three power socket fascias 10a, 10b, 10c. The features illustrated in FIG. 3 which correspond to figures already described in relation to FIG. 2 are denoted by like reference numerals, but with the addition of the letters a, b, or c to denote the power socket fascia 10a, 10b, 10c to which the features belong.

In the illustrated network 46, a “mains” power supply cable 48 terminates in a household consumer unit 50. From this consumer unit 50, power-line cable 22 is arranged in a “ring-circuit” and supplies electrical power to the power elements 30a, 30b, 30c of power socket fascias 10a, 10b, 10c respectively.

A telecommunications cable 52 (e.g. IDSN) terminates in a socket 54. A first data cable 56 connected to the socket 54 provides for data transfer between the socket 54 and a modem 57. In the illustrated network 46, modem 57 is supplied with electrical power by way of a power cable 58a connected to the power element 30a of power socket fascia 10a. The modem 57 is arranged to upload/download data signals to/from the power-line cable 22 and is connected to data port 20a of power socket fascia 10a by means of a second data cable 60a which terminates in a plug 62a which engages with data port 20a. A data signal uploaded from modem 57 is received at power socket fascia 10a, through data port 20a and is transferred to data processor 32a which, after processing the data signal, uploads data to the power-line cable 22 by way of branch line 34a. Similarly, data to be sent to the modem 57 from the power-line cable 22 passes through branch connection 34a to data processor 32a and is subsequently transmitted to modem 57 via data port 20a and second data cable 60a.

The illustrated network 46 of FIG. 3 also comprises network devices 64 and 66, such as two PC terminals. The network device 64 is coupled to power socket fascia 10b, and the network device 66 is coupled to power socket fascia 10c, and the devices 64, 66 are also arranged to receive power from the power socket fascias 10b, 10c in the same manner as described above in relation to modem 57 connected to power socket 10a, and can upload/download data to/from the power-line cable 22 in the same manner as described above for modem 57.

Thus, network 46 provides a local area network providing connectivity between modem 57, and network devices 64 and 66 by way of power-line cable 22 as the data signal transmission medium.

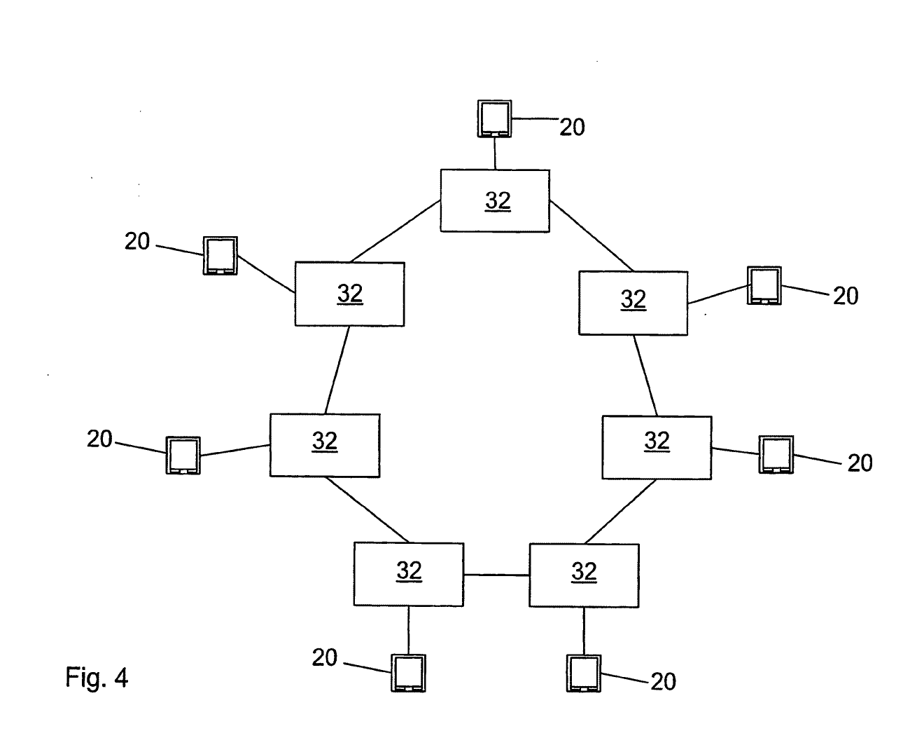

FIG. 4 is a schematic diagram showing the network elements of a basic powerline network. The network includes data ports 20 and data processors 32. In the preferred embodiment, the data ports 20 are Ethernet ports and the data processor includes a powerline chip. Each powerline chip is able to take data coming from a data port 20 and push it out to all of the other ports. The powerline chips handle data up to the 2^{nd} layer of the TCP/IP stack, i.e. up to the network layer. This makes the network act like a large Ethernet switch. The data processors are physically connected in a ring, for example by a ring main. Logically, each data processor may communicate with an other data processor without having to communicate with the other data processors.

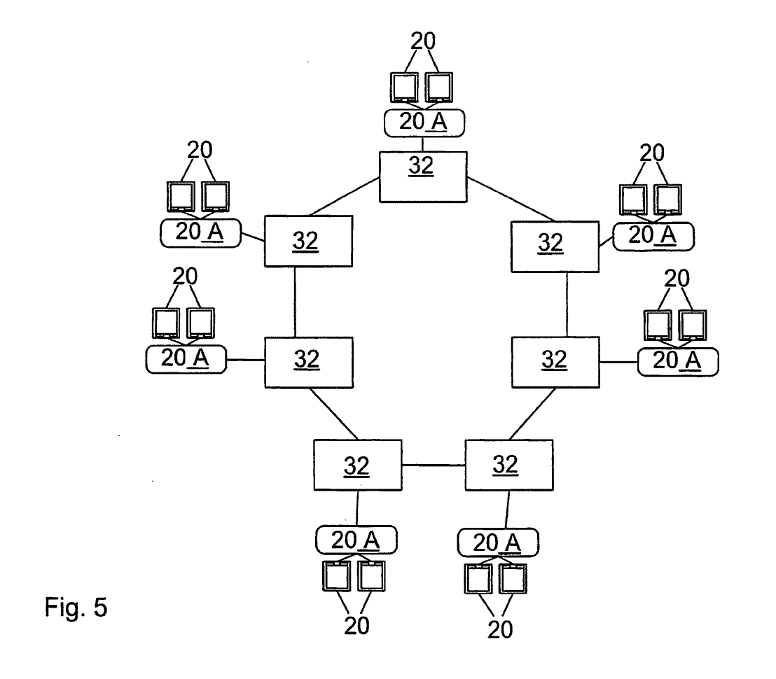

FIG. 5 is a schematic diagram showing the network elements of the power line network shown in FIG. 3. Each power socket fascia 10 includes two data ports 20 and a port switch 20A. This enables higher data rates between two ports on the same power socket fascia 10:

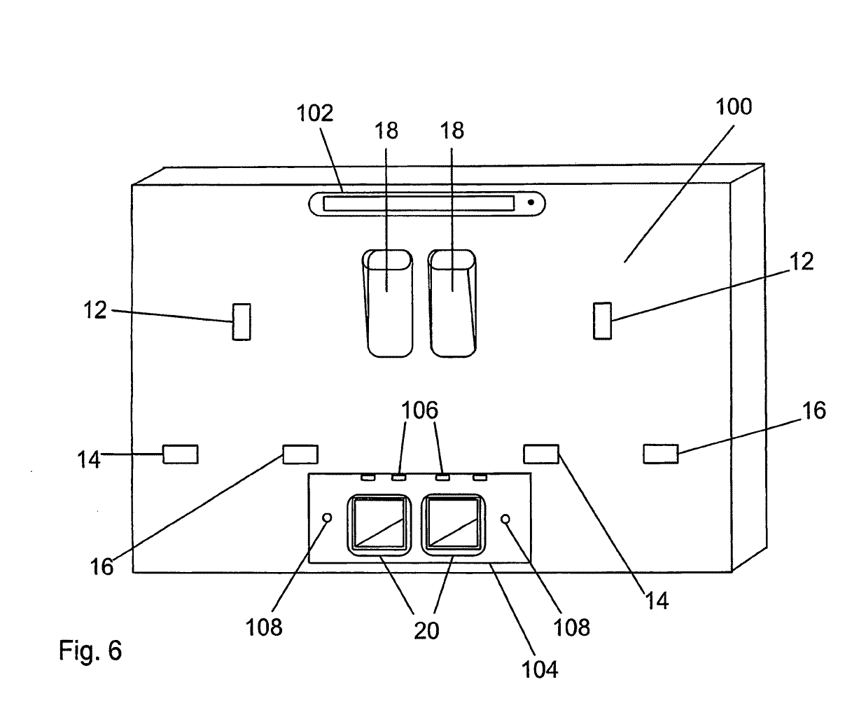

FIG. 6 illustrates an power socket fascia 100 in accordance with an embodiment of the invention. Features which are common with power socket fascia 10 are identified with the same reference numerals. Power socket fascia 100 comprises an LCD 102. The LCD 102 is for displaying the status and activity of the powerline connection. In addition, the LCD 102 may provide information relating to the status of other internal components of the power socket fascia 100. The operation of the LCD 102 will be described in more detail below.

The fascia 100 further comprises a recess for housing a cartridge 104. The cartridge 104 comprises the data ports 20. In this embodiment, the data ports are Ethernet data ports. The physical ports are therefore RJ45 ports. These ports include LEDs 106 which are arranged to provide an indication of the status and activity of the Ethernet connection, as will be described in more detail below. The cartridges also include screws 108 to hold the cartridge in place. Further details regarding these features are provided below.

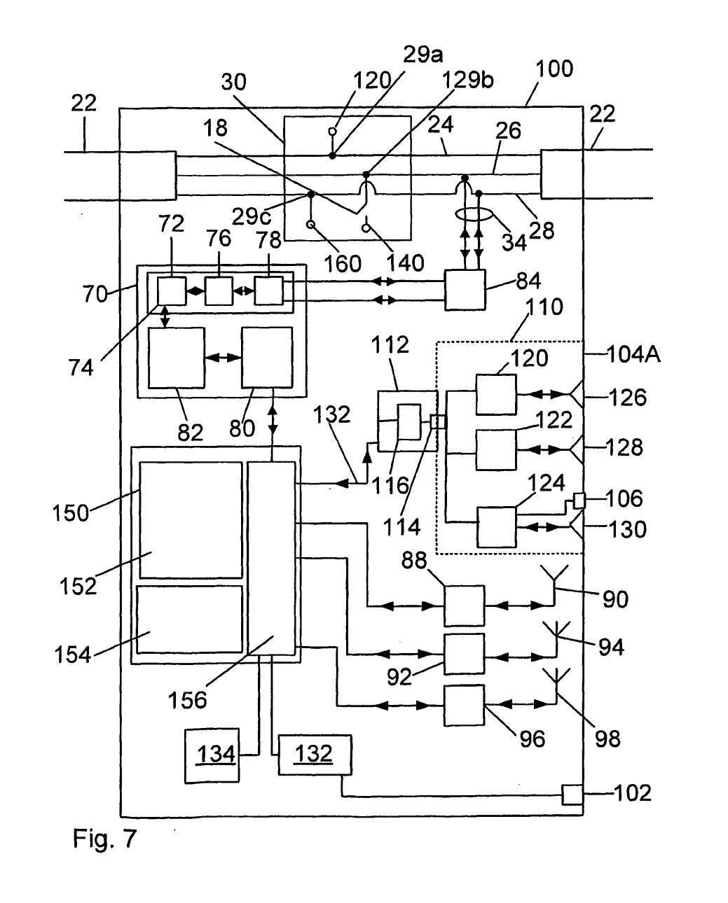

FIG. 7 illustrates the internal circuitry of the power socket fascia 100 schematically. Features which are common with the circuit illustrated in FIG. 2 are identified with like reference numerals.

The circuit show in FIG. 7 includes a power line processor 70. Power line processor 70 is a single integrated circuit which may for example be the INT6200 IC developed and manufactured by Intellon™ Corporation of 5100 West Silver Springs Blvd., Ocala, Fla., United States of America. The power line processor 70 includes analogue front end 72 which converts a digital signal to an analogue signal. The analogue front end 72 includes a signal converter 74, a signal amplifier 76 and a power line interface 78. These three parts of the processor 70 are equivalent to the signal converter 40, signal amplifier 38 and power line interface 36 shown in FIG. 3.

The power line processor 70 also includes a host interface 80 which includes a plurality of media independent interface (MII) connects. Each MII connection is used to connect to a different data port interface. The powerline processor 70 also includes HomePlug® MAC/PHY subsection 82. This is arranged to control the data signals passing through the powerline processor 70. The host interface 80 is connected to the HomePlug® MAC/PHY subsection 82 which is in tern connected to the analogue front end 72.

The circuit further comprises a coupling transformer 84. The input/output of the analogue front end 72 is coupled to the transformer 84. The transformer 84 is coupled to the live line 26 and the neutral line 28. The transformer 84 converts the output of the analogue front end 72 such that it is at an appropriate voltage and has an appropriate current for transmission over the power line 22.

The transformer 84 steps the voltage on the power line down to three different voltages. One of the voltages is for the network components such as Ethernet and WiFi™ which are described below. Another of the voltages is for the power line processor 70. Finally, a voltage is provided to run the other integrated circuits included in the device.

The power socket fascia 100 also includes a main processor 150. A suitable processor is the Qualcomm Snapdragon® developed and manufactured by Qualcomm Inc., of San Diego, United States of America. The main processor a processor core 152, random access memory (RAM) 154 and a bus 156 capable of handling the physical devices attached to it. The main processor 150 is connected to powerline processor 70. The operation of the processor 150 will be described in more detail below.

The power socket fascia further comprises a cartridge recess 110 (denoted by the broken line). The cartridge recess 110 is sized to allow a cartridge 104A to fit in the cartridge recess 110 so that the front of the cartridge 104A is flush with the front of the power socket fascia 100. The cartridge 104A is identical in size to cartridge 104 shown in FIG. 6. The cartridge 104A differs from cartridge 104 in that the data ports provided with the cartridge are of a different type, as will be described below. The power socket fascia 100 also includes a PCMCIA interface 112 which includes a PCMCIA socket for receiving a PCMCIA plug. The cartridge 104A includes a PCMCIA plug 114 which fits in to the PCMCIA socket. The PCMCIA plug includes a PCMCIA controller 116. The PCMCIA interface 112 connects the cartridge 104A to the processor bus 156 using a MII (Multimedia Independent Interface) connection 132.

The cartridge 104A includes three data ports. The cartridge includes a HDMI (High-Definition Multimedia Interface) data port interface 120, an audio data port interface 122 and an Ethernet data port interface 124. The cartridge includes respective HDMI, audio and Ethernet data ports 126, 128 and 130. Each of the data port interfaces is connected by a suitable bus to the PCMCIA plug 114.

The cartridge 104A may have a single data port, or it may have multiple data ports of different types. For example, the cartridge 104A may include asymmetric digital subscriber (ADSL) ports or optic fibre (FTTH) ports. It is also possible to include a modem within a cartridge.

The circuit shown in FIG. 7 also includes WiFi™ data port interface 88 which is connected to an antenna 90. The WiFi™ data port interface 88 is also connected by a MII connection to main processor bus 156. The circuit also includes an RFID data port interface 92 which is connected to an antenna 94. The RFID data port interface 92 is also connected by a MII connection to main processor bus 156. The power socket fascia 100 also includes a Bluetooth data port interface 96 which is connected to an Bluetooth antenna 98. The Bluetooth data port interface 96 is also connected by a MII connection to main processor bus 156. MII is convenient for the power socket fascia 100 processors because of its speed multiplication behaviour. Other interfaces such as PCI could also be used with other types of processors. For example, processors provided by other manufacturers or processors with different specifications.

As noted in connection with the corresponding feature of FIG. 2, the data port 130 is arranged to receive an RJ45-type plug attached to a Cat5 cable (or indeed any other suitable network cable) to allow a network device (e.g. a computer) to be connected for data exchange with power socket fascia 100. A data signal transmitted by the network device (not shown) is received at the power socket fascia 10 by the data port 20 (shown also in FIG. 2) and subsequently transferred to Ethernet data port interface 86.

The other data ports (i.e. 126, 128, 90, 94 and 98) operate in a similar manner. For example, WiFi™ data port interface 88, RFID data port interface 92 and Bluetooth data port interface are arranged to exchange data signals with appropriately configured computing devices.

The circuit shown in FIG. 7 also includes LCD 102. This is connected to an LCD control processor 132 which is in turn connected to the main processor bus 156. The main processor 150 outputs status and activity information signals. The LCD control processor 132 is programmed to recognise these signals and to display human readable information regarding the status and activity of the power socket fascia 100. An advantage of using an LCD is that is that the fascia does not have flashing lights on it which can be irritating to some consumers.

The data port interface 124 produces two additional output signals which provide an indication of a) the status of the data connection; and b) the activity over the data connection. As can be seen in FIG. 7, these outputs are coupled to LEDs 106. A first LED indicates whether or not the data connection is active. A second LED indicates whether or nor data is being sent over the data connection. Other data ports may have similar indications.

The power socket fascia further comprises read only memory (ROM) 134. ROM 34 has an embedded operating system (OS) (not shown) stored thereon. In use, the OS is loaded in to RAM 154. The OS comprises a series of instructions which are executed by the processor core 152. For the purposes of this description, the operation of the operating system will be described in functional terms. It will be appreciated by the skilled person that these functions are constituted by code instructions which are executed by the processor core 152.

The OS may be any OS suitable for carrying out the following functions. One such OS is LINUX OS provided by the Linux Foundation of San Francisco, United States of America.

Although the power socket fascia uses Linux, the powerline network remains the same. The powerline components become an interface on an OS instance (like interfaces for WiFi and Ethernet on a personal computer). This makes the power socket fascia 100 a device which operates at layer three (i.e. the transport layer) and above of the TCP/IP network stack. The fascia can therefore manage wireless connections, give out IP addresses, work out where something is via RFID and make the connection between a satellite television box and a television. It can also create a Bluetooth PAN (Personal Area Network) from Bluetooth devices installed in various sockets.

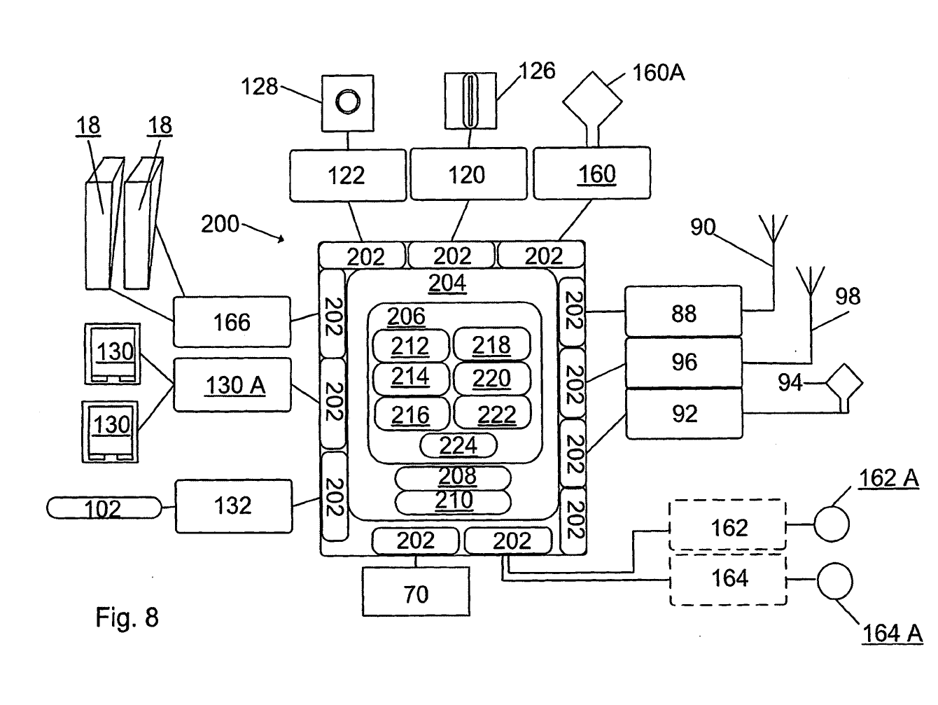

FIG. 8 shows a representation of the OS system model 200 together with a schematic representation of the various hardware elements which may be connected to the OS. The figure includes LCD control processor 132, an Ethernet switch 130A, switch actuators 166, audio data port interface 122, HDMI data port interface 120, an ultra wide band (UWB) data port interface 160, WiFi data port interface 88, Bluetooth data port interface 96, RFID data port interface 92, an ADSL data port interface 162, a optical fibre (FTTH) data port interface 164 and powerline processor 70.

Each of the aforementioned interfaces is connected to a respective data port. FIG. 8 shows, LCD 102, Ethernet data ports 130, switches 18, audio port 128, HDMI port 126, an UWM antenna 160A, antennas 90, 98 and 94 and ISP connections 162A and 164A.

It will be appreciated that not all of the above hardware elements are included in power socket fascia 100. Although this may be physically possible, it is unlikely in practice. The above elements are all shown in order to provide a better explanation of the operation of OS 200. Each hardware element is connected to the OS instance via a device driver 202. Device drivers 202 are pieces of code that are able to manipulate the hardware. The device drivers in turn are linked in an OS kernel 204. The kernel 204 controls the processor core 152, memory 154 and device drivers 202. The OS includes various user level applications 206 which run on the OS instance. The kernel 204 provides the applications 206 that with access to the hardware interfaces. The OS instance 200 also has a routing table 208 and a forwarding table 210 that allow the OS 200 to understand the other devices on the network (both powerline sockets and networked devices) so it knows where to forward information to.

The application 206 are present on each power socket fascia and control the sockets attributes. They can be controlled through a web interface (XML) from a third party application. This could be provided on a personal computer connected to the network at some point. Alternatively, the control could be provided by a dedicated panel at a convenient location at some point in the home or office.

The OS 200 includes an audio transport application 212, a video transport application 214, a Bluetooth PAN application 216, a QOS (Quality-of-Service) Manager application 218, and IP transport and security application 220, switch and panel manager application 222 and an XML interface application 222. The operation of the OS 200 will be described below.

Audio transport application 212 connects to an audio codec (part of the audio data port interface 120) through the kernel 204. It controls the codec to either transmit or receive streamed or non-streamed audio data. It also converts audio streams into an IP stream so that it can be pushed out through the powerline processor 70 to another OS instance. This process can be managed through the XML interface of each fascia.

The video transport application 214 works in much the same way as the audio transport application 212. However, it relies on having a good QoS and can set the powerline processor 70 accordingly so that a video stream is treated as a priority across the powerline network. Is can also set the video ports 126 as master or slave ports (master being a source device and slave being a destination device such as TV or mobile telephone). It also has the ability to scale the recoding base upon destination bandwidth.

Ultra wideband will be treated in the same way as video. This can be managed through the XML interface of each device.

The Bluetooth PAN application 216 control the setting up of PANs. PAN stands for personal access network. In this embodiment each OS instance 200 will have the ability to make a PAN from its Bluetooth data port interface 96. Different interfaces will be linked together using pin codes. The result is a single household PAN. Mobile phones, remote controls, headsets etc, can each connect to the household PAN. Again, this can be managed through the XML interface of each device.

The QoS manager application 218 manages the QoS on its outputs and inputs. Each fascia 100 will then have a set of parameters that it can set for the powerline processor 70, WiFi, Ethernet and audio/visual signals. A good example is a SKYPE™ call. This would be seen by the QoS manager application 218 and the call would be routed with IP tags of 1 (highest QoS band). This can be managed through the XML interface of each device.

The IP transport & security application 220 manages the security of each device and where the data is going. For example, it will manage WiFi inbound requests and authenticate them from what has been provided through the XML interface application 224. It also talks with the QoS manager 218 and outbound interfaces and is able to set parameters for each piece of hardware dependant on user controlled requirements. This can be managed through the XML interface 224 of each device.

The switch and panel manager 222 manages three elements. It is the configuration tool for the LCD 102 on each device. It can set what is shown, ambient lighting and backlight colour. It also controls the actuators in the switches which can be set to on or off. It also controls the cartridges that can be added. This can be managed through the XML interface of each device.

The XML interface application 224 provides an external interface allowing the fasciae to be controlled by a remote device.

In the following, further details of the manner in which OSs on different fascias communicate with each other are provided.

The OSs become network devices on the network. They appear as instances in the aforementioned routing and forwarding tables. Signals from the various devices are passed to the OS via the data port interfaces. The kernel drivers take the signal from a device and an OS application either converts the signal or manages by converting it to a IP layer data stream.

For example, a device connects to the WiFi antenna 90 in the fascia 100. The data comes through to a device driver 202 into the kernel 204. The kernel 204 then creates a socket for the incoming connection, calls the security application 220 to request authentication from the remote end. If authentication is successful, it allows the connection onto the power-line network. In this case, the OS only manages the connection.

Using Bluetooth the behaviour is slightly different. All of the fascias which include Bluetooth have to act like one entity. This means that authentication and PAN name has to be the same for each socket but also the sockets need to know where to route the connection. The Bluetooth radio accepts the connection into the device driver which creates a kernel request. This in turn calls the Bluetooth PAN application 216. This application has knowledge of all of the other Bluetooth devices in the network and stores this in a state file. For example, if a mobile phone is looking for a headset, the mobile phone creates a request in the Bluetooth PAN application 216. The application then wraps the stream in IP headers and sends it to the Bluetooth pan application 216 on the socket the headset is attached to.

For general networking, the OS manages the service elements and places traffic on the power-line network. For streaming, the applications wrap the protocol in IP headers and send them across the powerline network.

As noted above, the network may be controlled by an remote application. There is a shared DHCP pool between all of the sockets. This private IP space gets set up though the XML interface and will be managed by the remote application.

You can add more sockets and remove sockets from the cloud (changes if you move house or add a new room for example). The remote application will need to manage the sockets generally. It needs to be able to share the system data between the sockets. For example, if you add a new socket it will have its own management address that is always set as a default IP address (e.g. 10.0.0.1). The application, at first setup, can talk to the XML through the Ethernet port. The application will have the configurations for all of the sockets and will be able to download the state information once a valid IP address if given to the new socket. Furthermore, security can also be setup.

In FIGS. 7 and 8, various wireless technologies are mentioned. In the following further details are provided regarding the implementation of such technologies.

There are three main elements to a WiFi connection:
1: A WiFi processor to control the connection;
2: An ability to accept connections and do something with them. A name is required for a device to connect to, and, once past the WiFi processor, the data traffic needs to be sent somewhere; and
3: Security. It is well known that treating WiFi like Ethernet is bad because, unlike Ethernet, WiFi hotspots extend beyond the walls of your house. It is therefore subject to abuse by third parties.

As explained in the above, the WiFi device will be managed by the OS instance 200 and the IP transport and security application 220. All inbound requests will therefore be authenticated locally (or through a defined third party security method if required).

Bluetooth requires connections between the Bluetooth processors 96 in different wall sockets in order for them to act as a single Bluetooth entity. If every socket were to be treated as a separate entity, there would be too many Bluetooth devices to connect too. Once a Bluetooth connection is authenticated however, it's a similar network to a WiFi network as far smart devices are concerned. This needs to be managed by the Bluetooth PAN application 216.

UWB (Ultra Wide Band) is a very high bandwidth but ultra short range radio technology. It has many uses but in this context it will be for delivering high definition video signals without the use of wires. Much like HDMI, it needs a start point, and an end point.

RFID relies on multiple RFID radio devices working in parallel to pinpoint a tagged item. This radio wave technology is ideal for this application. It will be managed by the switch and panel manager application 222. The switch and panel manger application 222 will has the ability to share a table of all of the RFID processors, together with where they are geographically positioned. Thus, this allows triangulation to be carried out in order for an application querying the sockets to locate a particular tagged item.

The basic network shown in FIGS. 4 and 5 only network control up to the network layer. Higher layers are controlled by the devices connected to the Ethernet network. As can be understood from the above description, the use of OS 200 enables higher layers of the network stack to be controlled by the sockets themselves.

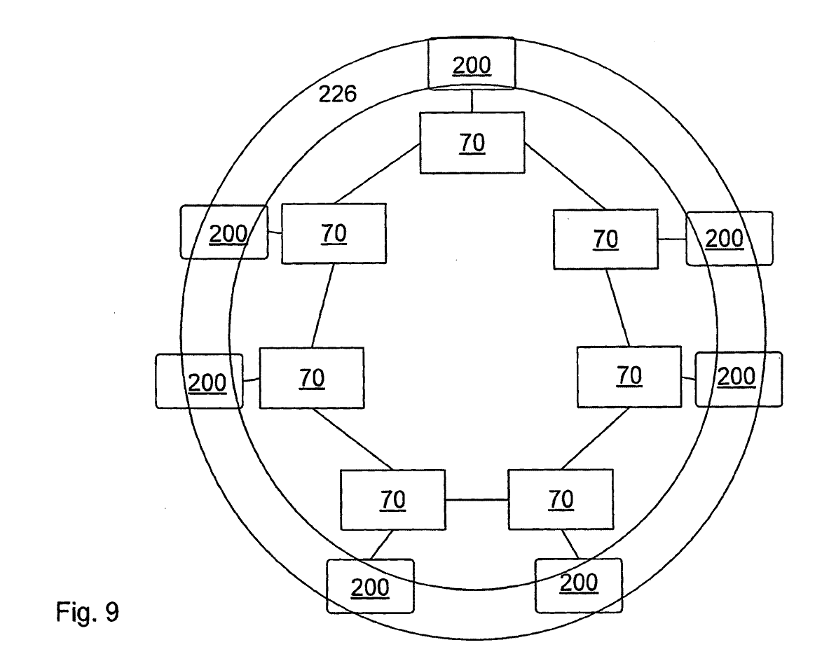

FIG. 9 shows a schematic diagram showing the network elements of a powerline network consisting of the number power socket fasciae 100. The network includes powerline processors 70 and OS instances 200. The OS instances 200 communicate with each other over an OS service management and routing layer. As can be seen, the powerline processors interface with the OS instances rather than the Ethernet switches of FIGS. 4 and 5.

Any data signals destined for the power lines are passed by the processor 150 to the HomePlug® MAC/PHY subsection 82 of the powerline processor 70. From here the signal is passed to analogue front end 72. The signal converter 74 is arranged to convert a digital data signal into an analogue data signal. This converted analogue data signal is then transferred to signal amplifier 76 and amplified to allow for better quality transmission of the signal over the power-line. After amplification in the signal amplifier 76, the converted analogue data signal is transferred to power-line interface 78 which transfers the converted analogue data signal to transformer 84. From here the signal is transferred to the earth and neutral lines 24, 28 of the power-line 22.

It will be appreciated that the circuit may include any number of data ports, as long as the may fit within the available space. In addition, the circuit may include a different selection of data ports to those described above.

As noted above in connection with the second embodiment, the data ports may be provided in cartridges. The power socket fasciae are not easily removable. Generally speaking, expert help or training is required to remove a socket completely. Even if one is able to remove a socket, it is still a fairly cumbersome activity. If new technologies become available, or if the user wishes to change the data port type for some other reason, the sockets facia must be completely replaced. By using cartridges, some of the functionality of each socket can be changed. The types of technology will be described in more detail below. The cartridge mechanism will be discussed first.

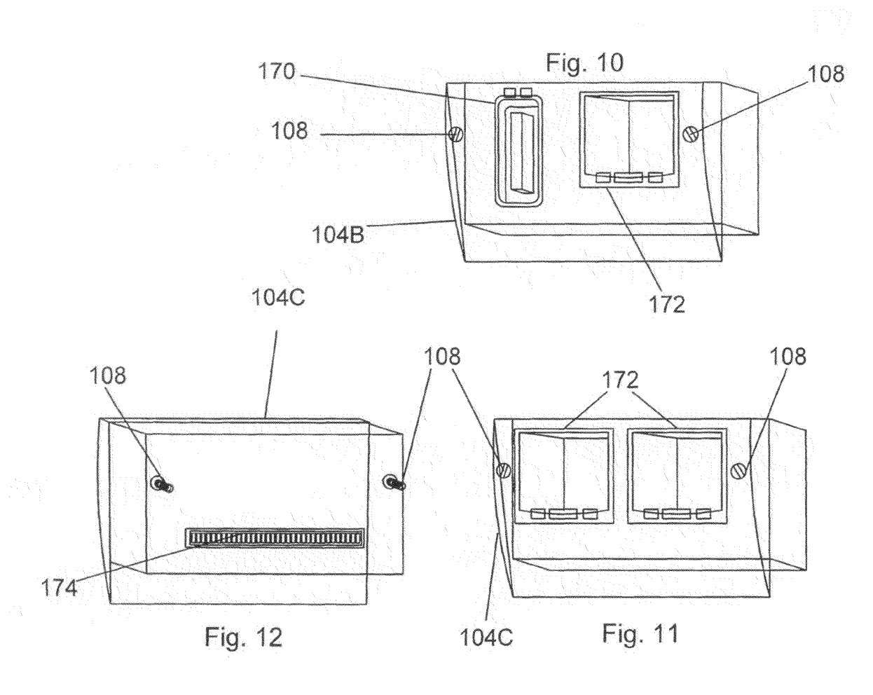

FIGS. 10, 11 and 12 show various perspective views of a cartridge in an embodiment of the invention. The cartridge system itself uses the PCMCIA ExpressCard system which allows interfaces to be “hot swappable”. The control mechanism 112 for the ExpressCard is on a bottom PCB in the back of the fascia. The cartridge has two guide rails, one on either side (left and right) and two small screws hold the cartridge in place. This also prevents children removing the cartridge. The cartridges will be soft insert.

FIG. 10 shows a front perspective view of a cartridge 104B. The cartridge includes a HDMI port 170 and an Ethernet port 172. In addition the cartridge includes screws 108. FIG. 11 shows a front perspective of an alternative cartridge 104C. HDMI port 170 is replaced by a further Ethernet port 172.

FIG. 12 shows a rear view of the cartridge 104C. The cartridge includes a PCMCIA plug for connecting to PCMCIA socket 114.

The cartridges may include audio (RCA), audio (SPDIF), video (HDM) or Ethernet 10/100 ports. Other types of ports may also be housed in a cartridge.

The two port Ethernet cartridge also has a switch so that local data transfer may be carried out without using the powerline network. For example, a personal computer can be connected to a games console where both are plugged into the Ethernet ports on the same socket. The devices can talk locally to each other without having to go out to the powerline network.

It is also possible to have back cartridges, although these are not shown. With the move to FTTH (optic fibres) and VDSL, connections can be terminated through the wall and fed into the back of a power socket. This further cuts down on in house wire clutter issues reduces the requirement for set top boxes, IP phones etc.

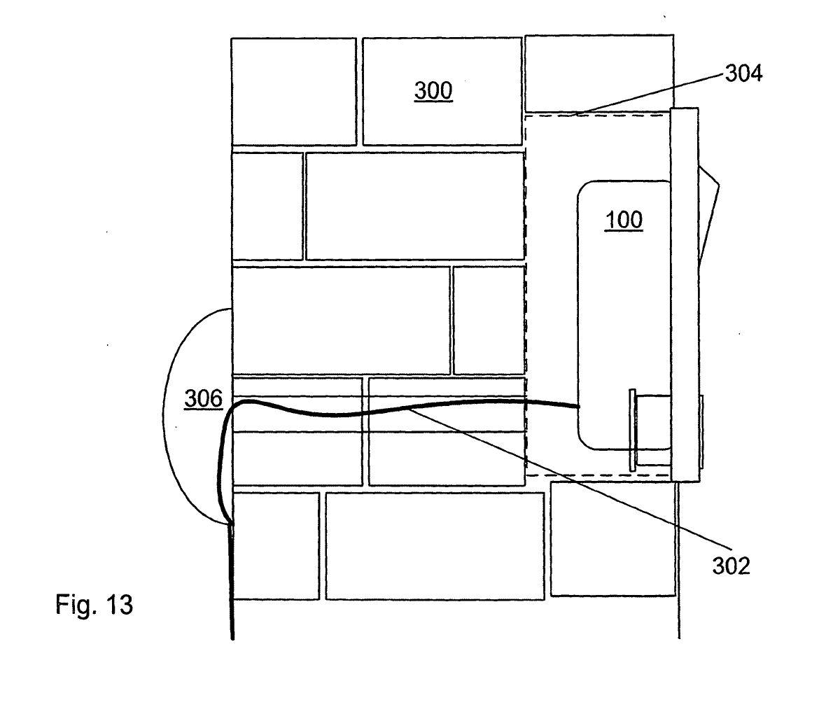

FIG. 13 shows a power socket fascia 100 in a wall 300. A connection 302 would enter the wall box 304 at the rear of the wall box. In this situation, the network operator could have control of the OS instance 200. Both the powerline processor 70 and the DSL/FTTH modem 306 utilise the TR69 standard for operator control:

In the following the physical layout of the internal components of the power socket fascia 100 is described. The internal board design has been chosen as a result of research in to the thermal dynamics of the socket in operation. A typical backbox is around 35 mm deep. However, standard powerline boards are typically at least 40 mm. The boards have therefore been redesigned to fir into a standard wall box. In particular, the components cannot fit on a single board. As will be seen in the following, a multi-layer board system has been adopted. Not only does this enable the components to fit in a standard back box, but it also helps with cable and heat dissipation management.

There are three layers to the design of the internals. This starts with a base layer. In a traditional socket fascia there is a set of bars that join the live, neutral and earth connections in a circuit. The wiring connectors are then placed into the centre of the socket which when in place constitutes the centre of the wall box.

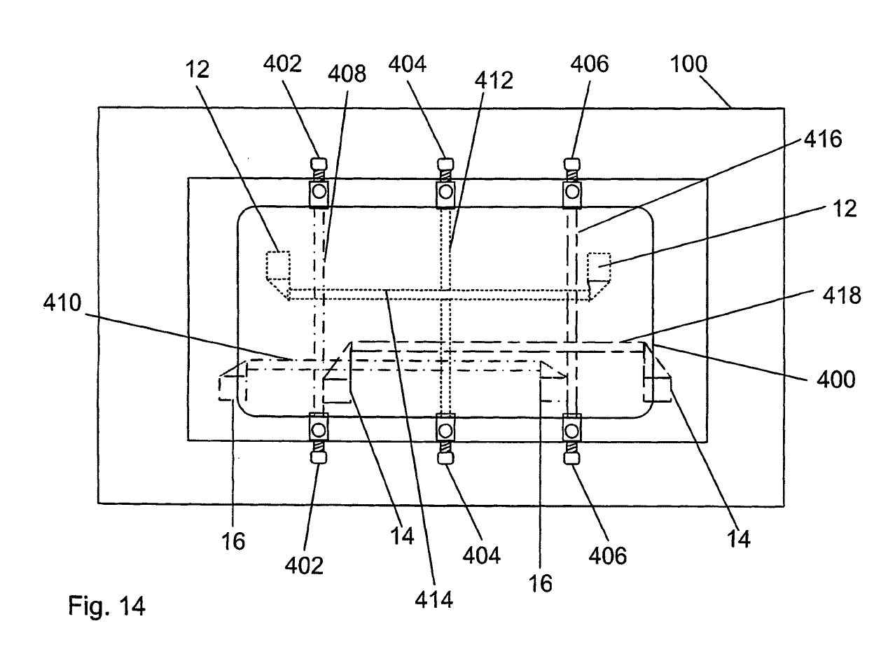

In the present embodiment, the base layer has been changed. This is to prevent the power lines, the electronics and the cooling mechanisms from interfering with each other. FIG. 14 shows the base layer 400 layout. Connections are provided at the top and bottom of the fascia (to allow for power line connections at the top and bottom of the wall box). The fascia 100 includes live connectors 402, earth connectors 404 and neutral connectors 406. Six bars connect the power lines to the power sockets. Bars 408 and 410 are for connection to live, bars 412 and 414 are for connection to earth and bars 416 and 418 are for connection to neutral.

As can be seen, the entry points have been adapted so that there are two entry points into the socket. One entry point is from the top and one entry point is from the bottom. In this manner, the centre of the socket space is left free for electronics and coverings.

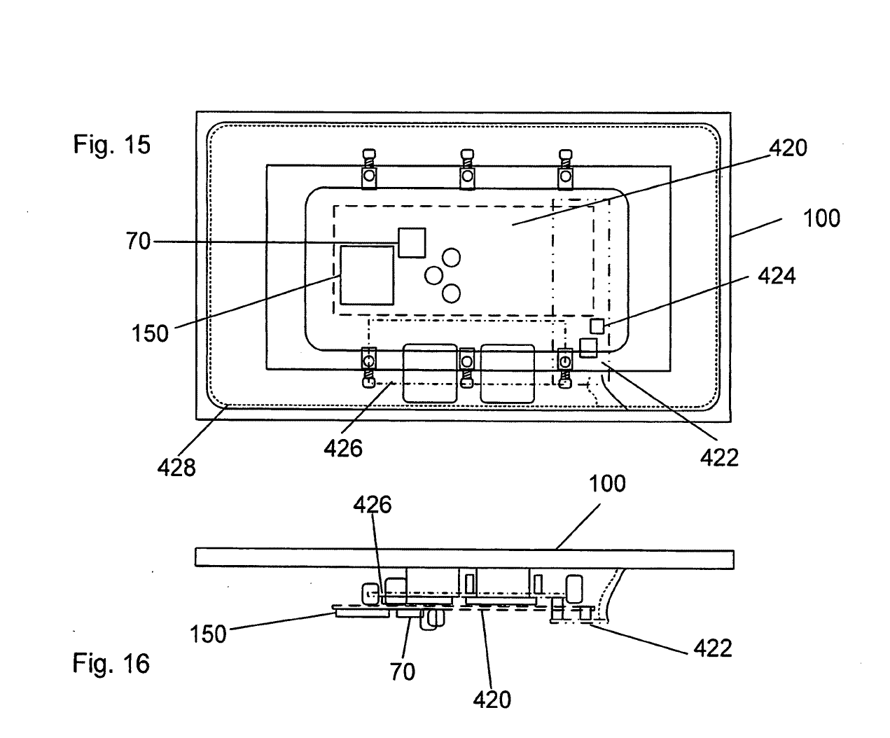

The next layer is the board layer. FIGS. 15 and 16 show how the circuit boards fit over the top of the socket and how they interact with each other. The fascia 100 includes a main board 420. The main board includes the powerline processor 70 and the main processor 150. A daughter board 422 includes Ethernet switching, WiFi 424, Bluetooth etc. Use of a daughter board allows for convenient replacement of parts on future fascias.

At the bottom of FIG. 15 there is a physical board 426 for the Ethernet sockets which will hold a PCMCIA bus for the cartridge system. This board controls the devices in the cartridge. On the right hand side of FIG. 15 there is riser board (daughter board) 422. The daughter board 422 holds all of the network driver components for Bluetooth, RFID and WiFi processors together with sundry board components. This board acts as to also boost the height and support the main board. The main board 420 in turn holds most other components. This being the powerline processor 70, the main processor 150, ROM, RAM (shared with the and not shown) and other sundry components. The main board 420 is double sided and the components have been placed so that the higher skyline items are placed facing the front of the fascia 100 and the one which run at higher temperatures are placed on the side facing the wall so as to aid cooling via a cooling outlet (not shown).

An advantage of the above arrangement is that the electronic circuitry can be placed into a fascia without fouling the power lines. Furthermore, by putting the power lines towards the top and bottom of the wall box, cooling is aided. Furthermore, the “skyline” in the backbox is kept to a minimum. Also shown in FIG. 15 is aerial 428. The aerial 428 is moulded into the plastic front of the power socket fascia 100. This has three advantages:

1. It aids reception considerably;
2. It stops unsightly aerials sticking out of the front of the device; and
3. It limits the amount of interference the components will be subjected to.

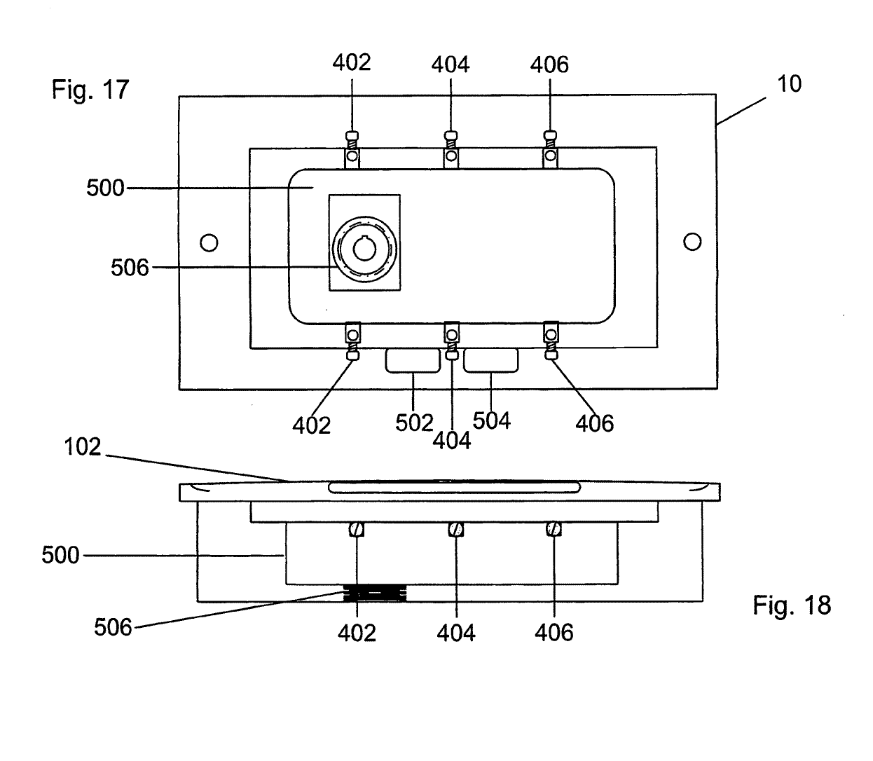

The data processor element of the power socket fascia, as well as other components, generate heat in use. This heat must be dissipated. When the power socket fascia is installed on a “back-box”, the data processor may be linked to the “back-box” to allow dissipation of heat through the “back-box”. An example of this is shown in FIGS. 17 and 18.

FIG. 17 shows a rear view of the power socket fascia 100. FIG. 18 shows a top view of power socket fascia 100. The power socket fascia 100 includes a component box 500. The component box 500 houses the electric circuit described above in connection with FIG. 7. Live connectors 402, earth connectors 404 and neutral connectors 406 are for forming the external connections with the ring main power line 22. In a typical back box (not shown) the power line is visible through a hole in the back box. The power socket fascia also includes data port socket recesses 502, 504 which house the data ports.

The component box 500 is sized such that, when fitted in a wall mounted back box, the rear surface of the component box 500 is spaced away from the rear surface of the back box. Typically the back component box 500 would be spaced around 5 to 20 mm away from the rear of the back box. A heat conductor 506 is attached to the rear of the component box 500. The heat conductor 506 is located in a position corresponding to the location of the main processor 150 or the power line processor 70. Preferably, component box 500 includes a thermal connection between the main processor 150 or power line processor 70 and the rear of the component box 500. For example, the PCB on which the processors are positioned may be affixed directly on to the rear side of the component box 500.

The heat conductor 506 may take the form of a heat conducting spring.

The spring is deep enough so that when the power socket fascia is fully inserted in the back box, the spring makes contact with the back of the back box. The combination of the heat conductor 506, the back box and the dry wall surrounding the back box therefore act as a heat sink. This prevents overheating of the circuit.

More than one heat conductor may be attached to the component box 500.

In the above description, it should be understood that the term “data port” can include a standard telephone socket, data socket, or any non-power socket.

It will be appreciated that although some data ports have been described as fixed modules, and some have been described as cartridge based modules, data ports may be provided in either form.

Although the above description relates to a power socket fascia which includes a data port to allow transfer of data signals over a powerline, there may additionally, or alternatively, include an audio port to allow transfer of audio signals over a powerline.

1. A power socket fascia arranged to be fitted to a power socket box, comprising: at least one power socket for receiving a plug of an electrical device and including coupling elements for electrically coupling said power socket to a power-line; and at least one port for the transmission and/or reception of a signal, wherein said at least one port is coupled to a first processor electrically coupled to said power-line and arranged to transfer a signal between said at least one port and said power-line so that said signal can be transmitted to and/or received from said power-line.

2. A power socket fascia according to claim 1, wherein said first processor comprises a power-line interface and a port interface, said power-line interface being arranged to extract a signal from said power-line and/or upload a signal onto said power-line, and also being arranged to forward an extracted signal to said port interface for transfer of the signal to said port, and which, upon receipt of a signal received at said port is arranged to transfer that signal to said power-line interface for upload to said power-line.

3. A power socket fascia according to claim 2, wherein said first processor further comprises a signal amplifier coupled between said power-line interface and said port interface and arranged to amplify a signal prior to transmission on said power-line and/or upon reception of a signal by said power-line interface and before transferring the signal to said port interface.

4. A power socket fascia according to claim 2 or 3, wherein said first processor comprises a signal converter arranged to convert said signal extracted by said power-line interface from analogue to digital or vice versa prior to transfer to said port interface, and to convert a signal received by said port interface from analogue to digital or vice versa, prior to transfer to said power-line interface for upload to said power-line.

5. A power socket fascia according to any one or more of the preceding claims, wherein said signal is a data signal, said port is a data port and said first processor is a data processor.

6. A power socket fascia according to any one or more of claims 1 to 4, wherein said signal is an audio signal, said port is a audio port and said first processor is an audio processor.

7. A power socket fascia according to claim 5, wherein said at least one data port comprises a socket arranged for receiving a plug of a data cable.

8. A power socket fascia according to claim 7, wherein, said plug comprises an RJ45-type plug.

9. A power socket fascia according to claim 7 or claim 8, wherein said plug comprises a USB-type plug.

10. A power socket fascia according to claim 6, wherein said at least one audio port comprises a socket arranged for receiving a plug of an audio cable.

11. A power socket fascia according to claim 10, wherein said plug comprises RCA audio, optical or RCA SPDIF digital type connector inputs or outputs.

12. A power socket fascia according to any one or more of the preceding claims, wherein said power line comprises a ring main.

13. A power socket fascia according to claim 12, wherein said ring main comprises a domestic ring main.

14. A power socket fascia according to any one or more of the preceding claims, wherein said at least one port comprises means for the wireless transmission/reception of a signal to/from a network device, or arranged for connection to a transmission/reception means.

15. A power socket fascia according to any preceding claim, wherein said data port is provided in a front face of said power socket fascia.

16. A power socket fascia according to an preceding claim, further comprising a track, which is embedded in the fascia and in which an omni-directional aerial set is laid.

17. A power socket fascia according to any preceding claim, wherein said fascia further comprises a data connection information display.

18. A power socket fascia according to any preceding claim, wherein said fascia further comprises a heat conductor arranged to conduct heat generated by a component of the fascia from the fascia to a said power socket box.

19. A power socket fascia according to any preceding claim further comprising memory on which an operating system (OS) is stored.

20. A power socket fascia according to claim 19, wherein said OS is arranged to control the operation of the power socket fascia.

21. A power socket fascia according claim 20, further comprising a second processor, arranged to execute instructions of said operating system.

22. A power socket fascia according to claims 19 to 21, wherein said OS includes a external interface arranged to enable remote control of said power socket fascia.

23. A power socket fascia according to claim 22, wherein said external interface is an XML interface.

24. A power socket fascia according to any preceding claim, wherein said fascia is arranged to provide network control.

25. A power socket fascia according to claim 24, wherein said power socket fascia is arranged to provide transport layer network control.

26. A power socket fascia according to any preceding claim further comprising a switch, which, in a first state allows current to flow from said power-line to said at least one power socket, and, in a second state, prevents current from flowing from said power-line to said at least one power socket.

27. A power socket fascia according to claim 26, further comprising a switch controller, arranged to allow the switch to be controlled remotely.

28. A power socket fascia according to claim 28, wherein said switch is a rocker switch and said switch controller is an actuator.

29. A power socket fascia according to any preceding claim, further comprising a data port at the rear of the fascia and arranged to accept a network cable connection from the power socket box.

30. A power socket fascia according to any preceding claim, further comprising a rear cartridge socket, positioned at the rear of the fascia, the rear cartridge socket arranged to receive a cartridge, the cartridge having at least one port for the transmission and/or reception of a signal.

31. A power socket fascia; according to any preceding claim, wherein said coupling elements are located towards the periphery of the fascia.

32. A power socket fascia according to any preceding claim, further comprising a main board on which said processors are located and a daughter board on which at least one data port interface is positioned.

33. A power socket fascia according to claim 32, wherein the main board is double sided and skyline components are arranged on a first side, oriented towards a front of the fascia, and components which become the hottest, in use, are arranged on a second side, oriented towards a back of the fascia.

34. A power socket fascia according to claim 33, wherein the power socket fascia includes power bars, which are arranged to provide space for the main board.

35. A power socket fascia arranged to be fitted to a power socket box, comprising: at least one power socket for receiving a plug of an electrical device and including coupling elements for electrically coupling said power socket to a power-line; a cartridge socket arranged to receive a cartridge, said cartridges having at least one port for the transmission and/or reception of a signal, wherein the fascia further comprises a processor electrically coupled to said cartridge socket and to said power-line and arranged, when a cartridge is located in said cartridge socket, to transfer a signal between said at least one port and said power-line so that said signal can be transmitted to and/or received from said power-line.

36. A power socket fascia according to claim 35, wherein said cartridge socket is not a power socket.

37. A power socket fascia according to claim 35, wherein said processor is connected to said cartridge using a PCMCIA interface.

38. A cartridge for insertion in the cartridge socket of the power socket fascia according to claim 35, the cartridge having at least one port for the transmission and/or reception of a signal.

39. A network comprising a plurality of network devices, each network device being coupled to one of a plurality of power socket fascias according to any one or more of the preceding claims, wherein said power socket fascias are arranged both to provide power outlets and to provide for signal transfer between said network devices, with said signal transfer being achieved through upload/download of signals via said at least one ports of the power socket fascias to/from a power-line.

40. A network according to claim 39, wherein a plurality of said fascias include Bluetooth data ports, and said fascias are arranged to form a personal area network.

41. A network according to claim 39, wherein a plurality of said fascias include RFID data ports and said fascias are arranged to enable the location of an RFID tag to be determined.

42. A network according to claim 39, wherein an RFID tag location is determined using triangulation.

43. A network according to claim 42, wherein said tag location may be determined by a remote device.

44. A network according to claim 39, wherein each said fascia includes an operating system arranged to control the network.

45. A power socket fascia substantially as hereinbefore described, with reference to, or as illustrated in, FIGS. 1 to 18 of the accompanying drawings.

46. A network substantially as hereinbefore described, with reference to, or as illustrated in, FIG. 3, 4, 5 or 9 of the accompanying drawings.

47. A cartridge substantially as hereinbefore described, with reference to, or as illustrated in, FIGS. 6 to 18.
